(19) United States
(12) Patent Application Publication
(10) Pub. No.: US 2005/0125224 A1
(43) Pub. Date: Jun. 9, 2005

(54) Method and apparatus for fusion of recognition results from multiple types of data sources

(76) Inventors: Gregory K. Myers, San Francisco, CA (US); Harry Bratt, Mountain View, CA (US); Anand Venkataraman, Palo Alto, CA (US); Andreas Stolcke, Berkeley, CA (US); Horacio F. Franco, Menlo Park, CA (US); Venkata Ramana Rao Gadde, Santa Clara, CA (US)

Correspondence Address: MOSER, PATTERSON & SHERIDAN L.L.P., 595 SHREWSBURY AVE, STE 100, FIRST FLOOR, SHREWSBURY, NJ, 07702, US

(21) Appl. No.: 10/983,505

(22) Filed: Nov. 8, 2004

Related U.S. Application Data
(60) Provisional application No. 60/518,201, filed on Nov. 6, 2003.

(51) Int. Cl. G10L 15/00

(52) U.S. Cl. 704/231

(57) ABSTRACT

A method and apparatus are provided for fusion of recognition results from multiple types of data sources. In one embodiment, the inventive method implementing a first processing technique to recognize at least a portion of terms contained in a first media source, implementing a second processing technique to recognize at least a portion of terms contained in a second media source that contains a different type of data than that contained in the first media source, and adapting the first processing technique based at least in part on results generated by the second processing technique.

### CROSS REFERENCE TO RELATED APPLICATIONS

This application claims the benefit of U.S. Provisional Patent Application Ser. No. 60/518,201, filed Nov. 6, 2003 (titled “Method for Fusion of Speech Recognition and Character Recognition Results”), which is herein incorporated by reference in its entirety.

### FIELD OF THE INVENTION

The present invention relates generally to image, text and speech recognition and relates more specifically to the fusion of multiple types of multimedia recognition results to enhance recognition processes.

### BACKGROUND OF THE DISCLOSURE

The performance of known automatic speech recognition (ASR) techniques is inherently limited by the finite amounts of acoustic and linguistic knowledge employed. That is, conventional ASR techniques tend to generate erroneous transcriptions when they encounter spoken words that are not contained within their vocabularies, such as proper names, technical terms of art, and the like. Other recognition techniques, such as optical character recognition (OCR) techniques, tend to perform better when it comes to recognizing out-of-vocabulary words. For example, typical OCR techniques can recognize individual characters in a text word (e.g., as opposed to recognizing the word in its entirety), and are thereby capable of recognizing out-of-vocabulary words with a higher degree of confidence.

Increasingly, there exist situations in which the fusion of information from both audio (e.g., spoken language) and text (e.g., written language) sources, as well as from several other types of data sources, would be beneficial. For example, many multimedia applications, such as automated information retrieval (AIR) systems, rely on extraction of data from a variety of types of data sources in order to provide a user with requested information. However, a typical AIR system will convert a plurality of source data types (e.g., text, audio, video and the like) into textual representations, and then operate on the text transcriptions to produce an answer to a user query.

This approach is typically limited by the accuracy of the text transcriptions. That is, imperfect text transcriptions of one or more data sources may contribute to missed retrievals by the AIR system. However, because the recognition of one data source may produce errors that are not produced by other data sources, there is the potential to combine the recognition results of these data sources to increase the overall accuracy of the interpretation of information contained in the data sources.

Thus, there is a need in the art for a method and apparatus for fusion of recognition results from multiple types of data sources.

### SUMMARY OF THE INVENTION

A method and apparatus are provided for fusion of recognition results from multiple types of data sources. In one embodiment, the inventive method implementing a first processing technique to recognize at least a portion of terms (e.g., words, phrases, sentences, characters, numbers or phones) contained in a first media source, implementing a second processing technique to recognize at least a portion of terms contained in a second media source that contains a different type of data than that contained in the first media source, and adapting the first processing technique based at least in part on results generated by the second processing technique.

### BRIEF DESCRIPTION OF THE DRAWINGS

The teachings of the present invention can be readily understood by considering the following detailed description in conjunction with the accompanying drawings, in which:

FIG. 1 is a flow diagram illustrating one embodiment of a method for fusion of recognition results from multiple types of data sources according to the present invention;

FIG. 2 is a flow diagram illustrating one embodiment of a method for fusion of recognition results from multiple types of data sources according to the present invention;

FIG. 3 is a schematic diagram illustrating exemplary result and spelling lattices representing recognized elements of the same word appearing in first and second media sources; and

FIG. 4 is a high level block diagram of the present method for fusing multimedia recognition results that is implemented using a general purpose computing device.

To facilitate understanding, identical reference numerals have been used, where possible, to designate identical elements that are common to the figures.

### DETAILED DESCRIPTION

The present invention relates to a method and apparatus for fusion of recognition results from multiple types of data sources. In one embodiment, the present invention provides methods for fusing data and knowledge shared across a variety of different media. At the simplest, a system or application incorporating the capabilities of the present invention is able to intelligently combine information from multiple sources that are available in multiple formats. At a higher level, such a system or application can refine output by identifying and removing inconsistencies in data and by recovering information lost in the processing of individual media sources.

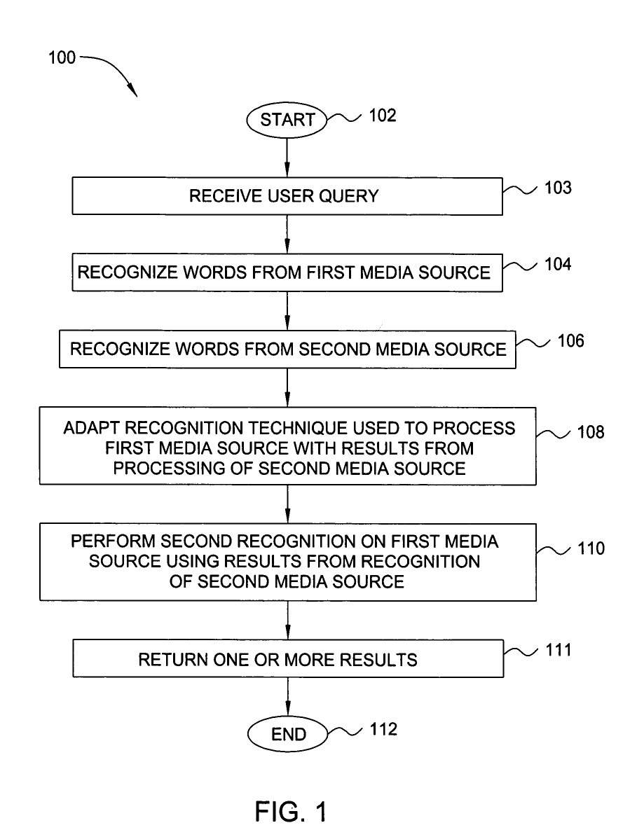

FIG. 1 is a flow diagram illustrating one embodiment of a method 100 for fusion of multiple types of data sources according to the present invention. In one exemplary embodiment, the method 100 may be implemented within an AIR system that accesses a variety of different types of multimedia sources in order to produce an answer to a user query. However, applicability of the method 100 is not limited to AIR systems; the method 100 of the present invention may be implemented in conjunction with a variety of multimedia and data processing applications that require fusion of data from multiple diverse media sources.

The method 100 is initialized at step 102 and proceeds to step 103, where the method 100 receives a user query. For example, a user may ask the method 100, “Who attended the meeting about issuing a press release? Where was the meeting held?”. The method 100 may then identify two or more media sources containing data that relates to the query and analyze these two or more media sources to produce a fused output that is responsive to the user query, as described in further detail below.

In step 104 the method 100 recognizes words from a first media input or source. In one embodiment, the first media source may include an audio signal, a video signal (e.g., single or plural frames), a still image, a document, an internet web page or a manual input (e.g., from a real or “virtual” keyboard, a button press, etc.), among other sources. Words contained within the first media source may be in the form of spoken or written (e.g., handwritten or typed) speech. For example, based on the exemplary query above, the first media source might be an audio recording of a meeting in which the following sentence is uttered: “X and Y attended a meeting in Z last week to coordinate preparations for the press release”.

Known audio, image and video processing techniques, including automatic speech recognition (ASR) and optical character recognition (OCR) techniques, may be implemented in step 104 in order to recognize words contained within the first media source. The processing technique that is implemented will depend on the type of data that is being processed. In one embodiment, the implemented processing technique or techniques produce one or more recognized words and an associated confidence score indicating the likelihood that the recognition is accurate.

In step 106, the method 100 recognizes words from a second media input or source that contains a different type of data than that contained in the first media source. Like the first media source, the second media source may include an audio signal, a video signal (e.g., single or plural frames), a still image, a document, an internet web page or a manual input (e.g., from a real or “virtual” keyboard, a button press, etc.), among other sources, and recognition of words contained therein may be performed using known techniques. For example, based on the exemplary query above, the second media source might be a video image of the meeting showing a map of Z, or a document containing Y (e.g., a faxed copy of a slideshow presentation associated with the meeting referenced in regard to step 104). In one embodiment, temporal synchronization exists between the first and second media sources (e.g., as in the case of synchronized audio and video signals). In one embodiment, steps 104 and 106 are performed sequentially; however, in another embodiment, steps 104 and 106 are performed in parallel.

In step 108, the method 100 adapts the recognition technique implemented in step 104 based on the results obtained from the recognition technique implemented in step 106 to produce enhanced recognition results. In one embodiment, adaptation in accordance with step 108 involves searching the recognition results produced in step 106 for results that are not contained within the original vocabulary of the recognition technique implemented in step 104. For example, if step 104 involves ASR and step 106 involves OCR, words recognized in step 106 by the OCR processing that are not contained in the ASR system's original vocabulary may be added to the ASR system's vocabulary to produce an updated vocabulary for use by the enhanced recognition technique. In one embodiment, only results produced in step 106 that have high confidence scores (e.g., where a “high” score is relative to the specific implementation of the recognition system in use) are used to adapt the recognition technique implemented in step 104.

In step 110, the method 100 performs a second recognition on the first media source, using the enhanced recognition results produced in step 108. In one embodiment, the second recognition is performed on the original first media source processed in step 104. In another embodiment, the second recognition is performed on an intermediate representation of the original first media source. In step 111, the method 100 returns one or more results in response to the user query, the results being based on a fusion of the recognition results produced in steps 104, 106 and 110 (e.g., the results may comprise one or more results obtained by the second recognition). In alternative embodiments steps 104-110 may be executed even before the method 100 receives a user query. For example, steps of the method 100 may be implemented periodically (e.g., on a schedule as opposed to on command) to fuse data from a given set of sources. In step 112, the method 100 terminates.

By fusing the recognition results of various different forms of media to produce enhanced recognition results, the method 100 is able to exploit data from a variety of sources and existing in a variety of formats, thereby producing more complete results than those obtained using any single recognition technique alone. For example, based on the exemplary query above, initial recognition performed on the first media source (e.g., where the first media source is an audio signal) may be unable to successfully recognize the terms “X”, “Y” and “Z” because they are proper names. However, by incorporating recognized words from the second media source (e.g., where the second media source is a text-based document) into the lexicon of the initial recognition technique, more comprehensive and more meaningful recognition of key terms contained in the first media source can be obtained, thereby increasing the accuracy of a system implementing the method 100.

The method 100 may even be used to fuse non-text recognition results with audio recognition results. For example, a user of an AIR system may ask the AIR system about a person whose name is mentioned in an audio recording of the meeting and whose face is viewed in a video recording of the same meeting. If the name is not recognized from the audio signal alone, but the results of a face recognition process produce a list of candidate names, those names could be added to the vocabulary in step 108.

Moreover, those skilled in the art will appreciate that although the context within which the method 100 is described presents only two media sources for processing and fusion, any number of media sources may be processed and fused to provide more comprehensive results.

Further, as discussed above, applicability of the method 100 is not limited to AIR systems; the method 100 may be implemented in conjunction with a variety of multimedia and data processing applications that require fusion of data from multiple diverse media sources. Thus, steps 103 and 111 are included only to illustrate an exemplary application of the method 100 and are not considered limitations of the present invention.

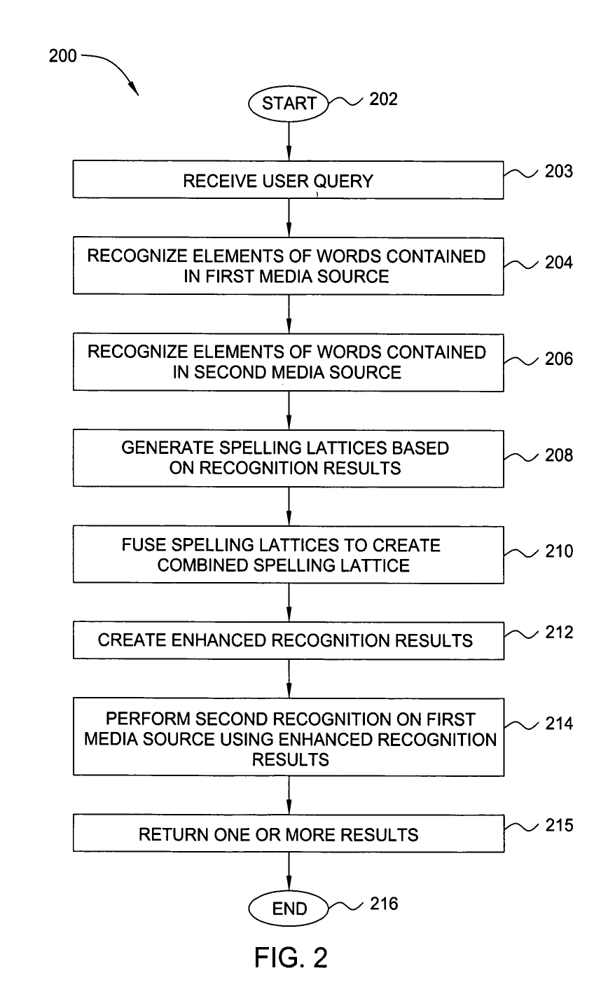

FIG. 2 is a flow diagram illustrating one embodiment of a method 200 for fusion of multiple types of data sources according to the present invention. Like the method 100 illustrated in FIG. 1, the method 200 is described within the exemplary context of an AIR system, but applicability of the method 200 may extend to a variety of multimedia and data processing applications that require fusion of data from multiple diverse media sources.

The method 200 is substantially similar to the method 100, but relies on the fusion of recognition results at the sub-word level as opposed to the word level. The method 200 is initialized at step 202 and proceeds to step 203, where the method 200 receives a user query. The method 200 may then identify two or more media sources containing data that relates to the query and analyze these two or more media sources to produce a fused output that is responsive to the user query, as described in further detail below.

In step 204, the method 200 recognizes elements of words contained in a first media input or source. Similar to the media sources exploited by the method 100, in one embodiment, the first media source may include an audio signal, a video signal (e.g., single or plural frames), a still image, a document, an internet web page or a manual input (e.g., from a real or “virtual” keyboard, a button press, etc.), among other sources. Words contained within the first media source may be in the form of spoken or written (e.g., handwritten or typed) speech. Thus, if the first media source contains audible words (e.g., in an audio signal), the elements recognized by the method 200 in step 204 may comprise individual phones contained in one or more words. Alternatively, if the first media source contains text words (e.g., in a video signal or scanned document), the elements recognized by the method 200 may comprise individual characters contained in one or more words.

Known audio, image and video processing techniques, including automatic speech recognition (ASR) and optical character recognition (OCR) techniques, may be implemented in step 204 in order to recognize elements of words contained within the first media source. The processing technique that is implemented will depend on the type of data that is being processed. In one embodiment, the recognition technique will yield a result lattice (i.e., a direct graph) of potential elements of words contained within the first media source. In one embodiment, the implemented processing technique or techniques produce one or more recognized elements and an associated confidence score indicating the likelihood that the recognition is accurate.

In step 206, the method 200 recognizes elements of words contained in a second media input or source that contains a type of data different from the type of data contained in the first media source. Like the first media source, the second media source may include an audio signal, a video signal (e.g., single or plural frames), a still image, a document, an internet web page or a manual input (e.g., from a real or “virtual” keyboard, a button press, etc.), among other sources, and recognition of words contained therein may be performed using known techniques. Also as in step 204, recognition of elements in step 206 may yield a result lattice of potential elements contained within one or more words, as well as confidence scores associated with each recognized element. In one embodiment, temporal synchronization exists between the first and second media sources (e.g., as in the case of synchronized audio and video signals). In one embodiment, steps 204 and 206 are performed sequentially; however, in another embodiment, steps 204 and 206 are performed in parallel.

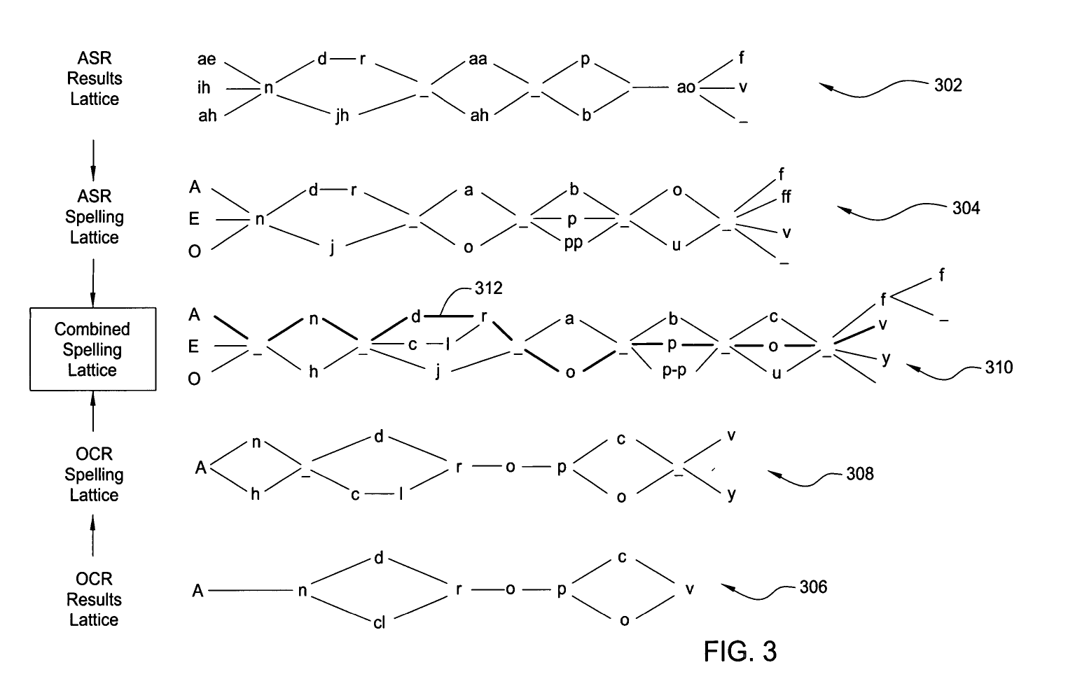

In step 208, the method 200 generates first and second spelling lattices from the result lattices produced in steps 204 and 206. FIG. 3 is a schematic diagram illustrating exemplary result lattices and spelling lattices representing recognized elements of the word “Andropov” in the first and second media sources. For example, if the first media source is an audio signal, ASR processing of the audio signal might yield a first result lattice 302 comprising a plurality of nodes (e.g., ae, ih, ah, n, d, r, jh, aa, ah, p, b, ao, f, v) that represent potential phones contained within the word “Andropov”. Furthermore, if, for example, the second media source is a text document, OCR processing of the text document might yield a second result lattice 306 comprising a plurality of nodes (e.g., A, n, d, cl, r, o, p, c, o, v) that represent potential characters contained within the word “Andropov”.

From the first and second result lattices 302 and 306, the method 200 generates first and second spelling lattices 304 and 308 that also contain a plurality of nodes (e.g., A, E, O, n, j, d, r, a, o, b, p, pp, o, u, f, ff, v for the first spelling lattice 304 and A, n, h, d, c, l, r, o, p, c, o, v, y for the second spelling lattice 308). The nodes of the first and second spelling lattices 304 and 308 represent conditional probabilities P(R|C), where R is the recognition result or recognized element (e.g., a phone or text character) and C is the true element in the actual word that produced the result R. In one embodiment, e.g., where the recognized elements are phones, these conditional probabilities are computed from the respective result lattice (e.g., first result lattice 302) and from a second set of conditional probabilities, P(true element|C), that describes the statistical relationship between the elements (e.g., phones) and the way that the elements are expressed in text form in the target language. In another embodiment, e.g., where the recognized elements are text characters, the conditional probabilities are computed by statistics that characterize the recognition results on a set of training data.

Referring back to FIG. 2, in step 210, the method 200 fuses the spelling lattices for the first and second media sources to produce a combined spelling lattice (e.g., combined spelling lattice 310 of FIG. 3). In one embodiment, this fusion is accomplished using a dynamic programming process that finds the best alignment of the first and second spelling lattices 304 and 308 and then computes a new set of conditional probabilities from the information in the first and second spelling lattices 304 and 308. A most probable path 312, illustrated in bold in FIG. 3, is then identified through the combined lattice, where the most probable path represents the likely spelling of a word contained in both the first and second media sources. In one embodiment, the most probable path 312 is computed using known techniques such as the techniques described in A. J. Viterbi, “Error Bounds for Convolutional Codes and an Asymptomatically Optimal Decoding Algorithm”, IEEE Trans. IT, vol. IT-13, pp. 260-269, 1967).

In one embodiment, fusion in accordance with step 210 also involves testing the correspondence between any lower-confidence results from the first media source and any lower-confidence words from the second media source. Because of the potentially large number of comparisons, in one embodiment, the fusion process is especially useful when the simultaneous appearance of words or elements in both the first and the second media sources is somewhat likely (e.g., as in the case of among multiple recorded materials associated with a single meeting).

In step 212, the method 200 creates enhanced recognition results based on the results of the combined spelling lattice 310. In one embodiment, this adaptation is accomplished by selecting recognized elements that correspond to the most probable path 312, and adding a word represented by those recognized elements to the vocabulary of a recognition technique used to process the first or second media source. In one embodiment, when a word is added to the vocabulary of a recognition technique, a pronunciation network for the word is added as well. The results illustrated in FIG. 3 yield two sources of information with which to generate a pronunciation network. In one embodiment, a pronunciation network is derived from the most probable path 312 using known spelling-to-pronunciation rules. In another embodiment, a pronunciation network can be used directly. In another embodiment, both of the techniques for generating a pronunciation network can be combined, for example, by a union or intersection of either a full lattice or selected portions of a lattice. Furthermore, a pronunciation network may be pruned based on acoustic match and confidence measures.

For example, in the embodiment where the first media source is processed using ASR techniques and the second media source is processed using OCR techniques, the method 200 may select the recognized phones that most closely correspond to the spelling along the most probable path 312 and add the word represented by the selected phones to the ASR technique's language model.

In step 214, the method 200 performs a second recognition on the first media source using a vocabulary enhanced with the results of the second recognition (e.g., as created in step 212). The method 200 then returns one or more results to the user in step 215. In step 216, the method 200 terminates.

The method 200 may provide particular advantages where the results generated by the individual recognition techniques (e.g., implemented in steps 204 and 206) are imperfect. In such a case, imperfect recognition of whole words may lead to erroneous adaptations of the recognition techniques (e.g., erroneous entries in the vocabularies or language models). However, recognition on the sub-word level, using characters, phones or both, enables the method 200 to identify a single spelling and pronunciation for each out-of-vocabulary word. This is especially significant in cases where easily confused sounds are represented by different looking characters (e.g., b and p, f and v, n and m), or where commonly misrecognized characters have easily distinguishable sounds (e.g., n and h, o and c, i and j). Thus, the method 200 is capable of substantially eliminating ambiguities in one modality using complementary results from another modality. Moreover, the method 200 may also be implemented to combine multiple lattices produces by multiple utterances of the same word, thereby improving the representation of the word in a system vocabulary.

In one embodiment, the method 200 may be used to process and fuse two or more semantically related (e.g., discussing the same subject) audio signals comprising speech in two or more different languages in order to recognize proper names. For example, a Spanish-language news report and a simultaneous English-language translation may be fused by producing individual phone lattices for each signal. Corresponding spelling lattices for each signal may then be fused to form a combined spelling lattice to identify proper names that may be pronounced differently (but spelled the same) in English and in Spanish.

As with the method 100, applicability of the method 200 is not limited to AIR systems; the method 200 may be implemented in conjunction with a variety of multimedia and data processing applications that require fusion of data from multiple diverse media sources. Thus, steps 203 and 215 are included only to illustrate an exemplary application of the method 200 and are not considered limitations of the present invention.

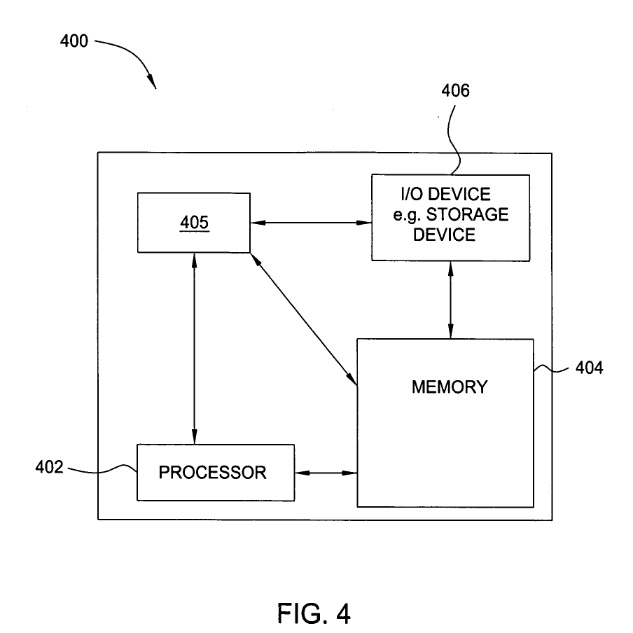

FIG. 4 is a high level block diagram of the present method for fusing multimedia recognition results that is implemented using a general purpose computing device 400. In one embodiment, a general purpose computing device 400 comprises a processor 402, a memory 404, a fusion engine or module 405 and various input/output (I/O) devices 406 such as a display, a keyboard, a mouse, a modem, and the like. In one embodiment, at least one I/O device is a storage device (e.g., a disk drive, an optical disk drive, a floppy disk drive). It should be understood that the fusion engine 405 can be implemented as a physical device or subsystem that is coupled to a processor through a communication channel.

Alternatively, the fusion engine 405 can be represented by one or more software applications (or even a combination of software and hardware, e.g., using Application Specific Integrated Circuits (ASIC)), where the software is loaded from a storage medium (e.g., I/O devices 306) and operated by the processor 402 in the memory 404 of the general purpose computing device 400. Thus, in one embodiment, the fusion engine 405 for fusing multimedia recognition results described herein with reference to the preceding Figures can be stored on a computer readable medium or carrier (e.g., RAM, magnetic or optical drive or diskette, and the like).

Those skilled in the art will appreciate that while the methods 100 and 200 have been described in the context of implementations that perform recognition of terms at the word and sub-word level (e.g., phone), the methods of the present invention may also be implemented to recognize terms including phrases, sentences, characters, numbers and the like.

Those skilled in the art will appreciate that the methods disclosed above, while described within the exemplary context of an AIR system, may be advantageously implemented for use with any application in which multiple diverse sources of input are available. For example, the invention may be implemented for content-based indexing of multimedia (e.g., a recording of a meeting that includes audio, video and text), for providing inputs to a computing device that has limited text input capability (e.g., devices that may benefit from recognition of concurrent textual and audio input, such as tablets PCs, personal digital assistants, mobile telephones, etc.), for training recognition (e.g., text, image or speech) programs, for stenography error correction, or for parking law enforcement (e.g., where an enforcement officer can point a camera at a license plate and read the number aloud, rather than manually transcribe the information). Depending on the application, the methods of the present invention may be constrained to particular domains in order to enhance recognition accuracy.

Thus, the present invention represents a significant advancement in the field of multimedia processing. In one embodiment, the present invention provides methods for fusing data and knowledge shared across a variety of different media. At the simplest, a system or application incorporating the capabilities of the present invention is able to intelligently combine information from multiple sources and available in multiple formats. At a higher level, such a system or application can refine output by identifying and removing inconsistencies in data and by recovering information lost in the processing of individual media sources.

Although various embodiments which incorporate the teachings of the present invention have been shown and described in detail herein, those skilled in the art can readily devise many other varied embodiments that still incorporate these teachings.

1. A method for fusing recognition results from at least two different media sources, the method comprising:
recognizing at least a portion of at least one term contained in a first media source using a first processing technique;
recognizing at least a portion of at least one term contained in a second media source using a second processing technique, where said second media source contains a type of data that is different from a type of data contained in said first media source; and
adapting said first processing technique based at least in part on a result generated by said second processing technique.

2. The method of claim 1, further comprising the step of:
implementing said adapted first processing technique to re-recognize at least a portion of at least one term contained in said first media source.

3. The method of claim 2, where said re-recognition is performed on said first media source in an original form.

4. The method of claim 2, wherein said re-recognition is performed on said first media source in an intermediate form.

5. The method of claim 1, wherein said first processing technique and said second processing technique are implemented sequentially.

6. The method of claim 1, wherein said first processing technique and said second processing technique are implemented in parallel.

7. The method of claim 1, wherein said first media source includes at least one of an audio signal, a video signal, a still image, a document, an internet web page and manually inputted text.

8. The method of claim 1, wherein said second media source includes at least one of an audio signal, a video signal, a still image, a document, an internet web page and manually inputted text.

9. The method of claim 1, wherein said adapting step comprises:
searching recognition results produced by said second processing technique for new words not contained within a vocabulary of said first processing technique; and
adding said new words to said vocabulary of said first processing technique.

10. The method of claim 1, wherein at least one of said first processing technique and said second processing technique is implemented to recognize sub-word elements.

11. The method of claim 10, wherein said sub-word elements comprise at least one of characters contained within text-based words or phones contained within spoken words.

12. The method of claim 11, wherein said first processing technique produces a first result lattice comprising one or more potential sub-word elements contained within said first media source, and said second processing technique produces a second result lattice comprising one or more potential sub-word elements contained within said second media source.

13. The method of claim 12, wherein said adapting step comprises:
generating a first spelling lattice based on said first result lattice;
generating a second spelling lattice based on said second result lattice; and
combining said first spelling lattice and said second spelling lattice to form a combined spelling lattice.

14. The method of claim 13, further comprising the steps of:
identifying a most probable path within said combined spelling lattice, where said most probable path represents a likely spelling of a word contained within said first and second media sources;
selecting recognized sub-word elements from said second media source that correspond to said most probable path; and
adding a word produced by said recognized sub-word elements to a vocabulary of said first processing technique.

15. The method of claim 1, wherein said at least one term is at least one of a phone, a word, a phrase a sentence, a character and a number.

16. A computer readable medium containing an executable program for fusing recognition results from at least two different media sources, where the program performs the steps of:
recognizing at least a portion of at least one term contained in a first media source using a first processing technique;
recognizing at least a portion of at least one term contained in a second media source using a second processing technique, where said second media source contains a type of data that is different from a type of data contained in said first media source; and
adapting said first processing technique based at least in part on a result generated by said second processing technique.

17. The computer readable medium of claim 16, further comprising the step of:
implementing said adapted first processing technique to re-recognize at least a portion of at least one term contained in said first media source.

18. The computer readable medium of claim 17, where said re-recognition is performed on said first media source in an original form.

19. The computer readable medium of claim 17, wherein said re-recognition is performed on said first media source in an intermediate form.

20. The computer readable medium of claim 16, wherein said first processing technique and said second processing technique are implemented sequentially.

21. The computer readable medium of claim 16, wherein said first processing technique and said second processing technique are implemented in parallel.

22. The computer readable medium of claim 16, wherein said first media source includes at least one of an audio signal, a video signal, a still image, a document, an internet web page and manually inputted text.

23. The computer readable medium of claim 16, wherein said second media source includes at least one of an audio signal, a video signal, a still image, a document, an internet web page and manually inputted text.

24. The computer readable medium of claim 15, wherein said adapting step comprises:
searching recognition results produced by said second processing technique for new words not contained within a vocabulary of said first processing technique; and
adding said new words to said vocabulary of said first processing technique.

25. The computer readable medium of claim 16, wherein at least one of said first processing technique and said second processing technique is implemented to recognize sub-word elements.

26. The computer readable medium of claim 25, wherein said sub-word elements comprise at least one of characters contained within text-based words or phones contained within spoken words.

27. The computer readable medium of claim 26, wherein said first processing technique produces a first result lattice comprising one or more potential sub-word elements contained within said first media source, and said second processing technique produces a second result lattice comprising one or more potential sub-word elements contained within said second media source.

28. The computer readable medium of claim 27, wherein said adapting step comprises:
generating a first spelling lattice based on said first result lattice;
generating a second spelling lattice based on said second result lattice; and
combining said first spelling lattice and said second spelling lattice to form a combined spelling lattice.

29. The computer readable medium of claim 28, further comprising the steps of:
identifying a most probable path within said combined spelling lattice, where said most probable path represents a likely spelling of a word contained within said first and second media sources;
selecting recognized sub-word elements from said second media source that correspond to said most probable path; and
adding a word produced by said recognized sub-word elements to a vocabulary of said first processing technique.

30. The computer readable medium of claim 16, wherein said at least one term is at least one of a phone, a word, a phrase a sentence, a character and a number.

31. Apparatus for fusing recognition results from at least two different media sources, the apparatus comprising:
means for recognizing at least a portion of at least one term contained in a first media source using a first processing technique;
means for recognizing at least a portion of at least one term contained in a second media source using a second processing technique, where said second media source contains a type of data that is different from a type of data contained in said first media source; and
means for adapting said first processing technique based at least in part on a result generated by said second processing technique.
